(19) United States
(12) Patent Application Publication
(10) Pub. No.: US 2024/0196305 A1
(43) Pub. Date: Jun. 13, 2024

(54) COMMUNICATION SYSTEM, RELAY APPARATUS, AND METHOD

(71) Applicant: CANON KABUSHIKI KAISHA, Tokyo (JP)

(72) Inventor: KOJI CHUREI, Kanagawa (JP)

(21) Appl. No.: 18/584,565

(22) Filed: Feb. 22, 2024

Related U.S. Application Data
(63) Continuation of application No. PCT/JP2022/025720, filed on Jun. 28, 2022.

(30) Foreign Application Priority Data
Aug. 24, 2021 (JP) 2021-136657

(51) Int. Cl. H04W 40/22

(52) U.S. Cl. CPC H04W 40/22

(57) ABSTRACT

In a communication system including at least an Integrated Access and Backhaul (IAB) donor connectable to a network, and an IAB node that is connected to the IAB donor and relays communication between a User Equipment (UE) and the IAB donor, the IAB donor transmits, to the IAB node as a destination and before relay processing is stopped, a message concerning stop of relay, the IAB node executes, based on reception of the message, processing for connection to another IAB donor connectable to the network before the IAB donor stops relay. The message concerning stop of the relay is different from a message that notifies a Backhaul Radio Link Failure (BH RLF).

### CROSS-REFERENCE TO RELATED APPLICATIONS

This application is a Continuation of International Patent Application No. PCT/JP2022/025720, filed Jun. 28, 2022, which claims the benefit of Japanese Patent Application No. 2021-136657 filed Aug. 24, 2021, both of which are hereby incorporated by reference herein in their entireties.

### BACKGROUND OF THE INVENTION

### Field of the Invention

The present invention relates to a path setting control technique in relay transmission.

### Background Art

In the Third Generation Partnership Project (3GPP®), IAB (Integrated Access and Backhaul) that forms a backhaul line using a wireless access line has been standardized (see Japanese Patent Laid-Open No. 2019-534625). In the IAB, a relay apparatus (IAB node) relays communication between a base station (IAB donor) and a terminal connected to the relay apparatus or another relay apparatus connected to the relay apparatus. When the IAB is used, a coverage area can be extended at low cost as compared to wired communication using conventional optical fibers.

### CITATION LIST

### Patent Literature

PTL 1: Japanese Patent Laid-Open No. 2019-534625

In the IAB, a radio link failure (RLF) may occur between an IAB donor and an IAB node or between IAB nodes because of a failure of a node or a change in a radio environment. In this case, an IAB node that is normally operating searches for another IAB node and performs reconnection processing, thereby continuing communication. However, the reconnection processing takes time, and there is a period in which the IAB node cannot perform communication. If the period is long, the efficiency of the entire system degrades.

### SUMMARY OF THE INVENTION

The present invention provides a technique for increasing the efficiency of connection destination change processing in a relay system.

According to one aspect of the present invention, there is provided a communication system including at least an Integrated Access and Backhaul (IAB) donor connectable to a network, and an IAB node that is connected to the IAB donor and relays communication between a User Equipment (UE) and the IAB donor, wherein the IAB donor comprises a transmission unit configured to transmit, to the IAB node as a destination and before relay processing is stopped, a message concerning stop of relay, the IAB node comprises a connection unit configured to execute, based on reception of the message, processing for connection to another IAB donor connectable to the network before the IAB donor stops relay, and the message concerning stop of the relay is different from a message that notifies a Backhaul Radio Link Failure (BH RLF).

According to another aspect of the present invention, there is provided a relay apparatus included in a relay path that relays communication between a network and a terminal, comprising: at least one memory that stores a set of instructions; and at least one processor that executes the instructions, the instructions, when executed, causing the relay apparatus to perform operations comprising: transmitting, before the relay apparatus stops relay, a message concerning stop of relay to a first another relay apparatus provided on a first relay path that relays wireless communication between the relay apparatus and the terminal on the relay path and connected to the relay apparatus, wherein the message is not transmitted to a second another relay apparatus provided on a second relay path that relays wireless communication between the relay apparatus and the network on the relay path and connected to the relay apparatus, and the message is different from a message that notifies a Backhaul Radio Link Failure (BH RLF).

According to still another aspect of the present invention, there is provided a relay apparatus included in a relay path that relays communication between a network and a terminal, comprising: at least one memory that stores a set of instructions; and at least one processor that executes the instructions, the instructions, when executed, causing the relay apparatus to perform operations comprising: receiving a message concerning stop of relay from a first another relay apparatus provided on a first relay path that relays wireless communication between the relay apparatus and the network on the relay path and connected to the relay apparatus; and executing, based on reception of the message, connection processing for connection to a second another relay apparatus connectable to the network before the first other relay apparatus stops relay.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a view showing an example of the configuration of a wireless communication network.

FIG. 2 is a view showing an example of the hardware configuration of an IAB node.

FIG. 3 is a view showing an example of the functional configuration of an IAB node.

FIG. 4 is a view showing an example of the configuration of a BAP PDU.

FIG. 5 is a flowchart showing an example of the procedure of processing of stopping backhaul communication by an IAB node.

FIG. 6 is a flowchart showing an example of the procedure of processing of changing a parent node by an IAB node.

FIG. 7 is a sequence chart showing an example of processing performed in the wireless communication network.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### (Network Configuration)

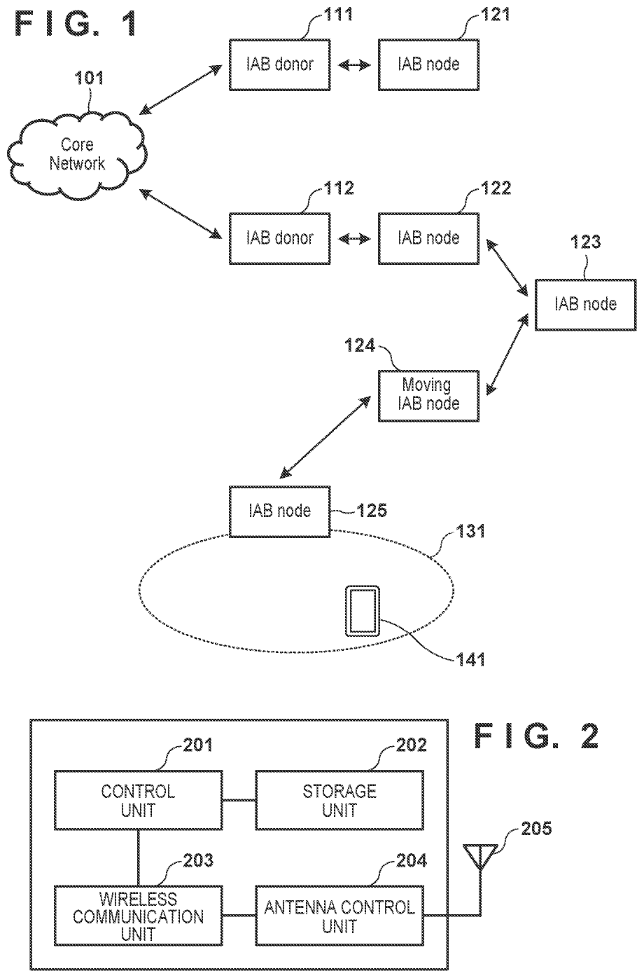

An example of the configuration of a wireless communication network according to this embodiment will be described with reference to FIG. 1. The wireless communication network is constructed based on IAB (Integrated Access and Backhaul) defined in the Third Generation Partnership Project (3GPP). In the wireless communication network, relay apparatuses (IAB nodes 121 to 125) relay communication between base stations (IAB donors 111 and 112) and a terminal 141. Note that the arrangement/configuration of the communication apparatuses (the IAB donors 111 and 112, the IAB nodes 121 to 125, and the UE 141) in FIG. 1 is merely an example, and the following discussion can be applied to another arrangement/configuration. Also, these communication apparatuses are communication apparatuses in a fifth generation (5G) access network which is also called an NR (New Radio) access network, and the IAB donors 111 and 112 and the IAB nodes 121 to 125 can each also be called a gNB. Note that the following discussion can be applied to a configuration using a network of another generation as well.

The IAB donors 111 and 112 control relay communication by the IAB nodes 121 and 122 directly connected to the self-apparatuses or by other IAB nodes 123 to 125 connected to the downstream of the IAB nodes. The IAB donors 111 and 112 are connected to a core network 101. It can be said that the IAB donors 111 and 112 provide, to the IAB nodes 121 to 125, connection to the core network 101. In this embodiment, communication between the core network 101 and the IAB donors 111 and 112 and the IAB nodes 121 to 125 is called backhaul communication. Also, in this embodiment, of two nodes directly connected in a communication path formed by relay, a node on a side close to the core network 101 is called a parent node, and a node on a side far from the core network 101 is called a child node. For example, the IAB donor 111 is the parent node of the IAB node 121, and the IAB node 121 is the child node of the IAB donor 111. The IAB node 122 is the child node of the IAB donor 112 and the parent node of the IAB node 123. Similarly, the IAB node 122 is the child node of the IAB node 122, and the parent node of the IAB node 124. Note that the example of FIG. 1 shows a configuration in which one child node is connected to one parent node. However, two or more child nodes may be connected to one parent node.

The IAB donors 111 and 112 each operate as a wireless base station in a cellular communication system. The IAB nodes 121 to 125 relay communication of the IAB donors 111 and 112. This allows a terminal (for example, the terminal 141) connected to the IAB nodes 121 to 125 to perform wireless communication under the control of the IAB donors 111 and 112. That is, the IAB nodes 121 to 125 operate as base stations viewed from the terminal. Note that FIG. 1 shows an example in which the terminal 141 exists, for example, in the range of a cell 131 in which the IAB node 125 provides a service and is connected to the core network 101 via the IAB nodes 122 to 125 and the IAB donor 112.

In such a wireless communication network, since nodes (IAB donors and IAB nodes) are wirelessly connected, a radio link failure (RLF) may occur in accordance with a change in a radio environment or function stop of a node. This RLF is called a Backhaul Radio Link Failure (BH RLF). Upon detecting a BH RLF, an IAB node notifies a child node of the occurrence of the BH RLF. For example, if a failure occurs in the IAB node 122, and wireless communication cannot be performed anymore, the IAB node 123 detects the radio failure and notifies the IAB node 124 of the BH RLF. Also, if a BH RLF is received from a parent node, and a child node to the self-apparatus exists, an IAB node notifies the child node of the BH RLF. For example, upon receiving a BH RLF, the IAB node 124 transmits the BH RLF to the IAB node 125. Upon receiving a BH RLF, each IAB node selects one apparatus from IAB nodes or IAB donors on the periphery and executes reconnection processing, thereby continuing backhaul communication.

Here, assume that the IAB node 124 is a movable communication apparatus, for example, an apparatus such as a drone that can move in the air or a vehicle such as a relay vehicle. When such a communication apparatus is moved to an area where no communication service can be provided only by a communication apparatus operable at the time of disaster or the like and made to operate as an IAB node, the communication service can be provided in the area. In an example, assume that in a state in which the IAB node 125 participates in the wireless communication network using the IAB node 123 as a parent node, the IAB node 124 starts operating in the wireless communication network. In this embodiment, the IAB node 124 is assumed to, for example, observe a signal sent from an IAB donor or an IAB node on the periphery and be connected to the IAB node 123 as a child node of the IAB node 123. In addition, the IAB node 125 is assumed to switch the parent node from the IAB node 123 to the IAB node 124. For example, if the communication quality of a signal from the IAB node 124 is higher than communication quality such as a radio wave strength of a signal from the IAB node 123, the IAB node 125 can switch the parent node to the IAB node 124. The IAB donor 112 may instruct the IAB node 125 to switch the parent node to the IAB node 124 based on a frequency band (frequency usage) used by the IAB node 123 or a processing load.

In this embodiment, it is assumed that if a predetermined time elapses from participating in the wireless communication network, the IAB node 124 leaves the wireless communication network. That is, it is decided in advance that the IAB node 124 stops the function as an IAB node. In this case, when the IAB node 124 leaves the wireless communication network after the elapse of the predetermined time, an RLF occurs, as in a case of a failure in the IAB node 124. On the other hand, interruption of communication of the IAB node 124 is scheduled in advance, and it is not efficient to perform the same procedure as in a conventional case of occurrence of an RLF. Hence, in this embodiment, the IAB node 124 transmits, to the IAB node 125 that is a child node, a relay stop announcing message indicating that communication as an IAB node is scheduled to be stopped. Accordingly, the IAB node 125 can recognize that communication with the IAB node 124 is scheduled to be interrupted, for example, specify an IAB node or an IAB donor as a reconnection destination in advance, and be connected to the specified connection destination before or immediately after occurrence of the RLF. It is therefore possible to shorten a period in which connection is disconnected by, for example, changing the connection destination immediately after or before occurrence of the scheduled RLF. Note that the IAB node 124 may, for example, decide stop of communication based on the state of the self-apparatus and transmit a message announcing the stop beforehand to the IAB node 125. For example, the IAB node 124 may decide the time to stop communication based on the remaining battery amount of the self-apparatus and transmit a relay stop announcing message according to that.

### (Apparatus Configuration)

The configuration of an IAB node according to this embodiment will be embodiment. Note that an IAB donor can have the same hardware configuration and functional configuration as the configuration of an IAB node to be described here. FIG. 2 shows an example of the hardware configuration of an IAB node. The IAB node is configured to include, for example, a control unit 201, a storage unit 202, a wireless communication unit 203, an antenna control unit 204, and an antenna 205. Note that the configuration shown in FIG. 2 is merely an example, a component that is not shown in FIG. 2 may be included in the IAB node, or at least some of the components shown in FIG. 2 may be replaced with other components or omitted. As for a component that is shown in FIG. 2 as only one component, a plurality of components may be prepared.

The control unit 201 is configured to include one or more processors such as a CPU (Central Processing Unit) or an MPU (Micro Processing Unit). Note that the processor may be a processor other than a CPU or an MPU, for example, an FPGA (Field Programmable Gate Array), a DSP (Digital Signal Processor), or an ASIC (Application Specific Integrated Circuit). The control unit 201 executes, for example, a control program stored in the storage unit 202, thereby controlling the entire apparatus. The storage unit 202 is configured to include one or more memories such as a ROM (Read Only Memory) or an RAM (Random Access Memory). The storage unit 202 may be configured to include a mass storage device such as a hard disk drive or a solid-state drive. The storage unit 202 stores various kinds of information, for example, a control program to be executed by the control unit 201, information of a cell formed by the self-apparatus or an adjacent cell, information of a terminal connected to the self-apparatus, and routing information of IAB. Various kinds of operations to be described later can be performed by the control unit 201 executing the control program stored in the storage unit 202.

The wireless communication unit 203 performs wireless communication in accordance with a cellular communication standard such as Long Term Evolution (LTE) or 5G complying with the 3GPP standard. Note that the wireless communication unit 203 may be configured to execute wireless communication according to a future cellular communication standard or a non-cellular standard. The antenna control unit 204 controls the antenna 205 to output a radio signal for wireless communication by the wireless communication unit 203 and accept a radio signal as an input from the outside. When, for example, searching for an IAB donor or IAB node that is a parent node candidate, the antenna control unit 204 controls the antenna 205 to receive a signal by a beam with a large beam width. When, for example, an apparatus of a connection destination is decided, the antenna control unit 204 controls the antenna 205 to form a beam with a small beam width for the apparatus. The antenna 205 can be, for example, an antenna having a characteristic for enabling communication in both a frequency band such as the 28-GHz band used for backhaul communication and a frequency band used for communication with a terminal. Note that the antenna 205 may be an antenna array in which a plurality of antenna elements are arranged in an array.

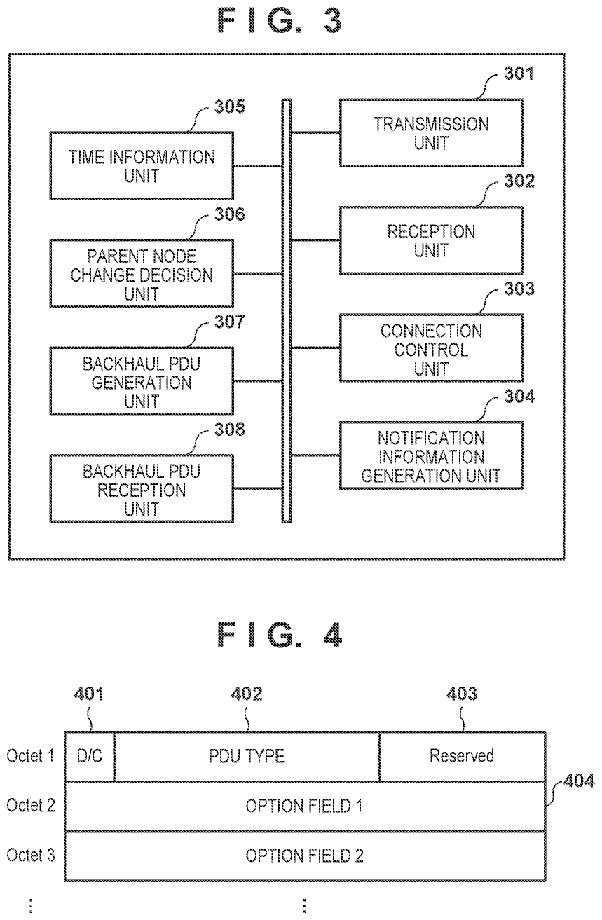

Next, an example of the functional configuration of an IAB node will be described with reference to FIG. 3. Note that each function to be described below can be implemented by, for example, the control unit 201 executing a program stored in the storage unit 202. Some or all of the functions to be described below may be implemented by dedicated hardware. Note that some or all of the functions described below may be replaced with another functional configuration or omitted. The IAB node includes, as its functions, for example, transmission unit 301, a reception unit 302, a connection control unit 303, a notification information generation unit 304, a time information unit 305, a parent node change decision unit 306, a backhaul PDU generation unit 307, and a backhaul PDU reception unit 308.

The transmission unit 301 transmits various kinds of signals (including frames and information) to another communication apparatus via the wireless communication unit 203. The reception unit 302 receives various kinds of signals from another communication apparatus via the wireless communication unit 203. The connection control unit 303 executes connection control to another communication apparatus by communication using the transmission unit 301 and the reception unit 302. The connection control unit 303, for example, transmits/receives a radio resource control (RRC) message using the transmission unit 301 and the reception unit 302, thereby executing processing associated with connection or disconnection to or from another communication apparatus. The notification information generation unit 304 generates notification information including system information about a cell provided by the IAB node itself. This notification information is periodically transmitted by the transmission unit 301. Another communication apparatus (another IAB node or terminal) receives the notification information, thereby recognizing that the IAB node exists on the periphery of the self-apparatus and performing connection processing to the IAB node.

The time information unit 305 executes acquisition of time information via a network or timer processing up to a predetermined time. The parent node change decision unit 306 decides whether to change the parent node in backhaul communication. The parent node is a node which exists on the core network side of the self-apparatus in the communication path for backhaul communication and to which the self-apparatus is directly connected, as described above. The parent node change decision unit 306 can decide to change the parent node if deterioration of radio quality is detected in the link between the self-apparatus and the parent node or if a BH RLF is detected in the link or a link on the upstream side (core network side). Also, the parent node change decision unit 306 may change the parent node based on a specific instruction, received from an IAB donor, indicating that the parent node should be changed.

The backhaul PDU generation unit 307 generates a PDU (Protocol Data Unit) to be transmitted/received to/from a communication apparatus (an IAB donor or another IAB node) in backhaul communication. Note that the PDU is a PDU based on the BAP (Backhaul Adaptation Protocol) and is also called a BAP PDU. Data transfer for backhaul communication or notification of a control message is performed using the BAP PDU, and the BAP PDU is transmitted to another communication apparatus by the transmission unit 301. The backhaul PDU reception unit 308 receives a BAP PDU from another communication apparatus via the reception unit 302, analyzes the received BAP PDU, and acquires included information. FIG. 4 shows an example of the configuration of the BAP PDU. As shown in FIG. 4, the BAP PDU is configured to include, for example, a D/C field 401, a PDU type field 402, a Reserved field 403, and an option field 404. The D/C field 401 is a 1-bit field. If the value is set to “0”, it indicates that the BAP PDU is a control message, and if the value is set to “1”, it indicates that the BAP PDU is data. The PDU type field 402 is formed by 4 bits, and indicates the type of a control message. For example, if the value is set to “0011”, it indicates that the control message is a BH RLF. The Reserved field 403 is a reserved field that is not used. The option field 404 is a field that stores additional information. Fields after Octet 2 of the BAP PDU are each used as the option field 404.

In this embodiment, if the IAB node decides to stop backhaul communication before the stop, the backhaul PDU generation unit 307 generates a BAP PDU announcing the relay stop beforehand. The BAP PDU announcing the relay stop beforehand will be referred to as a relay stop announcing message hereinafter. Since the relay stop announcing message is a control message, the D/C field 401 is set to “0”, and the PDU type field 402 is set to a value indicating the relay stop announcing message. The value indicating the relay stop announcing message can be, for example, “0100”, but another value may be used if it is not a duplicate of the value of another PDU type. In this embodiment, for example, information indicating the parent node to which the IAB node of the transmission source of the relay stop announcing message is connected can be stored in the option field 404 as additional information. Note that this is merely an example, and a relay stop announcing message including another appropriate information may be formed. For example, the IAB node may store a scheduled time to stop backhaul communication as additional information in the option field 404.

### (Procedure of Processing)

An example of the procedure of processing executed by an IAB node will be described next. Note that in an example, each process to be described below can be implemented by the control unit 201 executing a program stored in the storage unit 202. Some or all of the processes to be described below may be implemented by dedicated hardware.

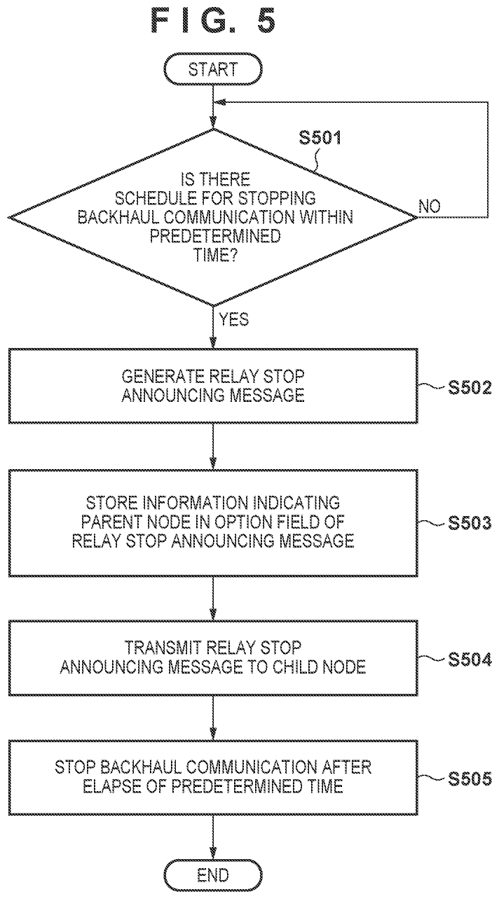

FIG. 5 shows an example of the procedure of processing of stopping backhaul communication by the IAB node 124. This processing is started when, for example, the IAB node 124 participates in a wireless communication network to perform backhaul communication. This processing can repetitively be executed, for example, at a predetermined time interval. This processing can be executed not only by the IAB node 124 but also by an arbitrary communication apparatus that can participate in a wireless communication network as shown in FIG. 1 and operate as an IAB node, and can also perform an operation of stopping backhaul communication.

In the processing shown in FIG. 5, the IAB node 124 determines whether backhaul communication is scheduled to be stopped within a predetermined time from the current time (step S501). In the IAB node 124, for example, the time information unit 305 measures the time elapsed from participating in the wireless communication network as shown in FIG. 1 and determines whether it is a predetermined time before (for example, five min before) the stop of backhaul communication. That is, the IAB node 124 is set to operate, for example, only for a predetermined time (for example, 2 hrs), and determines whether a time obtained by subtracting a predetermined time from the predetermined time has elapsed, thereby determining whether it is a predetermined time before the stop of backhaul communication. At the timing at which it is determined to stop backhaul communication within the predetermined time (YES in step S501), the IAB node 124 advances the process to step S502. Note that if a new request for connection is received from another IAB node or terminal after it is determined to stop backhaul communication within the predetermined time, the IAB node 124 may reject the connection request. The IAB node 124 may set, for example, a second predetermined time for deciding whether to reject a new connection request separately from a first predetermined time used in the determination of step S501. That is, for example, after determining, in step S501, to stop backhaul communication within the first predetermined time, the IAB node 124 may accept a new connection request until the time up to the stop of backhaul communication reaches the second predetermined time. Also, for example, the IAB node 124 may stop accepting a new connection request if the time up to the stop of backhaul communication reaches the second predetermined time before determining, in step S501, to stop backhaul communication within first predetermined time.

Note that in the above-described example, the predetermined time is 5 min. However, a value other than this may be used. Also, in the above-described example, the IAB node 124 determines, based on the time elapsed from participating in the wireless communication network, whether it is a predetermined time before the stop of backhaul communication. However, the present invention is not limited to this. For example, a network operator or the like sets the time to stop backhaul communication in advance, and the IAB node 124 determines whether the time up to the time is equal to or less than the predetermined time, thereby determining whether it is the predetermined time before the stop of backhaul communication. Also, the IAB node 124 can be configured to estimate, based on, for example, a remaining battery amount usable for communication, a time length in which backhaul communication can be executed. In this case, if the time length is equal to or less than the above-described predetermined time, the IAB node 124 may determine to stop backhaul communication within the predetermined time.

If the predetermined time or less remains up to the stop of backhaul communication, in the IAB node 124, the backhaul PDU generation unit 307 generates a relay stop announcing message (step S502). For example, as described above, the relay stop announcing message is a BAP PDU in which the D/C field 401 is set to “O”, and the PDU type field 402 is set to “0100”. In the IAB node 124, the backhaul PDU generation unit 307 sets information indicating the parent node to which the self-apparatus is currently connected in the option field 404 of the relay stop announcing message generated in step S502 (step S503). The information indicating the parent node can be, for example, a gNB ID included in notification information transmitted from the parent node. Here, the JAB node 124 stores information indicating the JAB node 123 in the option field 404 of the relay stop announcing message. In the IAB node 124, then, the transmission unit 301 transmits the generated relay stop announcing message to a child node (step S504). Here, the JAB node 124 transmits the relay stop announcing message to the JAB node 125. Based on the elapsed time measured by the time information unit 305, the JAB node 124 stop backhaul communication based on reaching the scheduled time to stop backhaul communication (step S505).

In this way, the JAB node 124 transmits the relay stop announcing message to the child node and then stops backhaul communication. According to this, the child node can recognize that the radio link with the JAB node 124 is to be disconnected after a predetermined time, and the child node (IAB node 125) can, for example, execute measurement or connection destination change for connection with the parent node of the JAB node 124. Note that in the above-described example, the relay stop announcing message is transmitted by the BAP PDU. The relay stop announcing message may be output as notification information without specifying the destination.

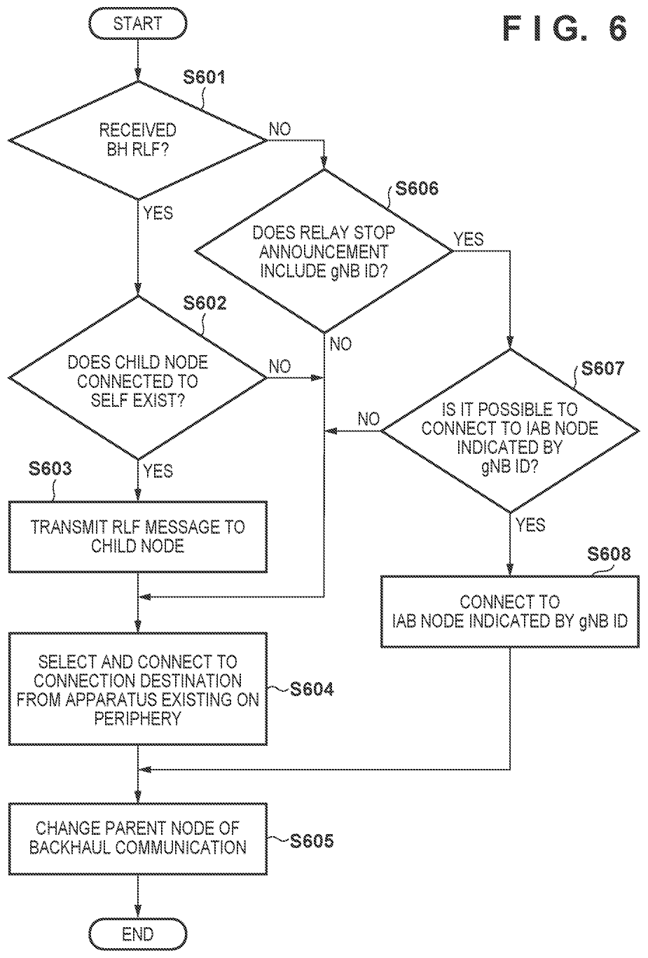

Next, an example of the procedure of processing of changing the parent node by the JAB node 125 will be described with reference to FIG. 6. This processing is started when, for example, the JAB node 125 receives a BAP PDU indicating a BH RLF or a relay stop announcing message. Note that the JAB node 125 may receive another control message in which the D/C field 401 is set to “0”, but the JAB node 125 can be configured to, in this case, perform processing according to the type of the message and not to execute processing shown in FIG. 6. This processing can be executed not only by the IAB node 125 but also by an arbitrary communication apparatus that can participate in a wireless communication network as shown in FIG. 1 and operate as an IAB node.

In this processing, the IAB node 125 determines whether a BAP PDU received during execution of communication indicates a BH RLF (step S601). Upon receiving a BAP PDU indicating a BH RLF (YES in step S601), the IAB node 125 recognizes that an RLF has occurred on the upstream side of the self-apparatus. For example, if an RLF is detected by the IAB node 124 because of a failure in the IAB node 123, a BAP PDU indicating a BH RLF is received. In this case, the IAB node 125 determines whether a child node connected to the self-apparatus exists (step S602). If a child node exists (YES in step S602), the IAB node 125 generates a BH RLF message and transmits it to the child node (step S603). If no child node exists (NO in step S602), the IAB node 125 does not perform the processing. After that, the IAB node 125 obtains IAB nodes or IAB donors existing on the periphery as candidates for the parent node, selects one apparatus from these, and performs connection processing (step S604). The IAB node 125 can recognize an IAB node or IAB donor existing on the periphery based on, for example, receivable notification information. If a plurality of IAB nodes or IAB donors exist on the periphery, the IAB node 125 selects the apparatus of the connection destination based on a predetermined criterion that, for example, the reception strength of an arriving radio wave has a predetermined value or more or is highest, or the hop count to the core network is small. Then, the IAB node 125 changes the parent node to the apparatus connected in step S604 (step S605), and continues backhaul communication.

If the received BAP PDU is a relay stop announcing message (NO in step S601), the IAB node 125 determines whether information (for example, a gNB ID) of the parent node of the transmission source (IAB node 124) of the message is included in the message (step S606). If the information is not included (NO in step S606), the IAB node 125 advances the process to step S604, obtains IAB nodes or IAB donors existing on the periphery as candidates for the parent node, selects one apparatus from these, and performs connection processing (step S604). Then, the IAB node 125 changes the parent node to the apparatus connected in step S604 (step S605), and continues backhaul communication. That is, if the gNB ID is not included in the relay stop announcing message, the IAB node 125 searches for candidates for the parent node and executes switching of the parent node in accordance with the reception of the message. If information (gNB ID) of the parent node of the IAB node 124 is included (YES in step S606), the IAB node 125 determines whether it can be connected to the node indicated by the information (step S607). For example, the IAB node 125 determines whether the reception strength of a signal transmitted from the parent node of the IAB node 124 is a predetermined level or more, thereby determining whether it can be connected to the node. Upon determining that the IAB node 125 can be connected to the node (YES in step S607), the IAB node 125 is connected to the node (step S608), changes the parent node to the apparatus connected in step S608 (step S605), and continues backhaul communication.

As shown in FIG. 6, even in a case where a child node is connected, if the relay stop announcing message is received, the IAB node 125 does not relay the message, and only the self-apparatus can change the connection destination. According to this, since connection change is not performed in an apparatus on the downstream side (the side to separate from the core network 101) of the IAB node 125, the time of connection disconnection in each node can be made short. In addition, if the IAB node 125 can be connected to the parent node of the IAB node 124, the IAB donor 112 of the connection destination does not change. Hence, processing such as resetting of a BAP address need not be performed. It is therefore possible to reduce the processing load such as path resetting.

Note that if the relay stop announcing message includes information of the scheduled time at which the IAB node 124 stops backhaul communication, the IAB node 125 can execute parent node change processing such that the change of the parent node is completed until the scheduled time. Note that this is merely an example, and, for example, only completing, until the scheduled time, the search of another communication apparatus that should be the parent node after the change may suffice. In this case, in response to the scheduled time, the parent node may be changed to the communication apparatus searched in advance. Alternatively, the IAB node 125 may complete the change of the connection destination until the scheduled time, and in response to the scheduled time, relay path setting processing for the change of the parent node may be done.

In a case where the relay stop announcing message is transmitted, it is assumed that the IAB node 124 is not stopped at the time of step S605, and no RLF occurs on the upstream side. Hence, if it is scheduled that an RLF occurs due to relay stop of the IAB node 124, the IAB node 125 can change the parent node before the RLF actually occurs and thus suppress interrupt of backhaul communication. Note that upon receiving the relay stop announcing message, the IAB node 125 may not immediately perform parent node switching processing and may perform only the search of the parent node candidate and decision of the connection destination. For example, if an RLF due to the stop of the IAB node 124 is detected, the IAB node 125 may execute connection processing to the node of the connection destination decided in advance. This can also shorten the period to interrupt backhaul communication as compared to a case where candidates for the connection destination are searched for after an RLF occurs.

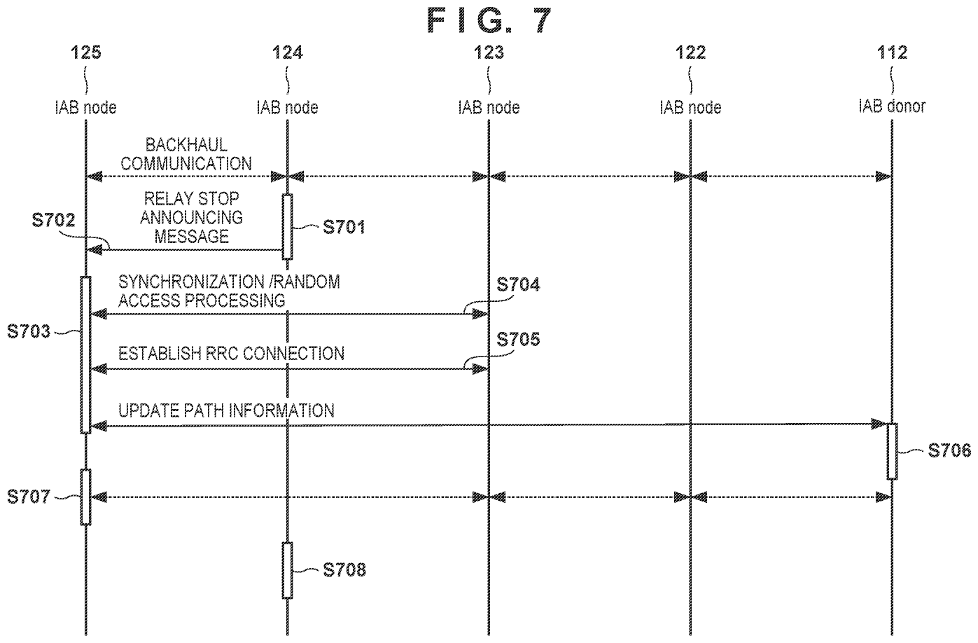

Next, an example of the procedure of processing executed in the wireless communication network shown in FIG. 1 will be described with reference to FIG. 7. FIG. 7 shows an example of the procedure of processing in a case where the IAB node 124 is scheduled in advance to stop relay due to movement or the like, the relay stop announcing message is transmitted to the IAB node 125, and the IAB node 125 switches the parent node. Initially, it is assumed that the IAB donor 112, the IAB node 122, the IAB node 123, the IAB node 124, and the IAB node 125 are connected in this order, and backhaul communication is performed between these nodes.

In this processing, the IAB node 124 determines whether backhaul communication is scheduled to stop within a predetermined time (S701). Note that this determination processing can be executed in each IAB node and the IAB donor as well. However, an apparatus that never stops unless, for example, maintenance or the like is scheduled can be configured not to perform the determination processing unless information such as the maintenance schedule is input. Upon judging that backhaul communication is scheduled to stop within a predetermined time, the IAB node 124 transmits a relay stop announcing message to the child node (IAB node 125) (S702).

Upon receiving the relay stop announcing message, the IAB node 125 determines, based on, for example, information of the parent node (IAB node 123) of the IAB node 124 in the relay stop announcing message, whether the IAB node 125 can communicate with the IAB node 123. If the information of the parent node of the IAB node 124 is not included in the relay stop announcing message, the IAB node 125 can search for an IAB node or IAB donor that can set a relay path to the core network and exists on the periphery. Here, assume that as the result of one of these processes, the IAB node 125 decides to connect the IAB node 123 and executes connection processing (S703). The IAB node 125 establishes synchronization of the downlink based on a synchronization signal transmitted from the IAB node 123, and also executes random access processing to execute establishment of synchronization of the uplink (S704). Furthermore, the JAB node 125 establishes connection in a radio resource control (RRC) layer to the JAB node 123 (S705).

If connection to the JAB node 123 is established, the JAB node 125 then performs updating processing of relay path information to the IAB donor 112. By this setting processing, the IAB donor 112 updates the information of the relay path to the JAB node 125 (S706). For example, the IAB donor 112 changes the relay path up to the JAB node 125 from a relay path passing through the IAB node 122, the JAB node 123, and the JAB node 124 to a relay path passing through only the IAB node 122 and the IAB node 123. After that, the JAB node 125 switches backhaul communication using the JAB node 124 as the parent node to backhaul communication using the JAB node 123 as the parent node without interposing the IAB node 124 (S707). On the other hand, the IAB node 124 stops backhaul communication after the elapse of a predetermined time (S708).

According to this embodiment, based on the schedule of the JAB node 124 to stop relay, the child node of the JAB node 125 changes the connection destination before the scheduled time and resets the relay path. For this reason, as compared to a case where the connection destination is switched after an RLF occurs due to the actual stop of relay by the JAB node 124, the time of interrupt of backhaul communication can greatly be shortened. In addition, the relay stop announcing message is transmitted only to the child node directly connected to the JAB node that stops relay, and only the child node changes the connection destination. This can prevent another JAB node connected on the downstream side of the child node from changing the connection destination. According to this, it is possible to change the relay path while suppressing the load concerning the change of the connection destination. Also, if an JAB node is connected to the parent node of the JAB node that stops relay, processing such as BAP address setting can be omitted, and therefore, the processing load can be reduced.

Note that in the above-described embodiment, processing performed in a case where an IAB node scheduled to stop relay concerning a relay communication path based on IAB exists has been described. The same processing as described above can be performed in a relay transmission system not based on IAB. That is, in a general relay transmission system including two or more relay apparatuses, if a first relay apparatus is scheduled to stop relay, a relay stop announcing message can be transmitted to a second relay apparatus connected to the opposite side (terminal side) of the network side (base station side). Accordingly, as described above, before the relay is actually stopped in the first relay apparatus, the second relay apparatus can change the connection destination. It is therefore possible to shorten the period of disconnection of the relay path as compared to a case where after processing of searching for and changing the connection destination by the second relay apparatus after the first relay apparatus stops relay is performed.

According to the present invention, it is possible to efficiently change a connection destination in a relay system.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication system including at least an Integrated Access and Backhaul (IAB) donor connectable to a network, and an IAB node that is connected to the IAB donor and relays communication between a User Equipment (UE) and the IAB donor, wherein
the IAB donor comprises a transmission unit configured to transmit, to the IAB node as a destination and before relay processing is stopped, a message concerning stop of relay,
the IAB node comprises a connection unit configured to execute, based on reception of the message, processing for connection to another IAB donor connectable to the network before the IAB donor stops relay, and
the message concerning stop of the relay is different from a message that notifies a Backhaul Radio Link Failure (BH RLF).

2. A relay apparatus included in a relay path that relays communication between a network and a terminal, comprising:
at least one memory that stores a set of instructions; and
at least one processor that executes the instructions, the instructions, when executed, causing the relay apparatus to perform operations comprising:
transmitting, before the relay apparatus stops relay, a message concerning stop of relay to a first another relay apparatus provided on a first relay path that relays wireless communication between the relay apparatus and the terminal on the relay path and connected to the relay apparatus,
wherein the message is not transmitted to a second another relay apparatus provided on a second relay path that relays wireless communication between the relay apparatus and the network on the relay path and connected to the relay apparatus, and the message is different from a message that notifies a Backhaul Radio Link Failure (BH RLF).

3. The relay apparatus according to claim 1, wherein the message concerning stop of the relay is a message that announces stop of relay beforehand.

4. The relay apparatus according to claim 2, wherein the message further includes information of the second other relay apparatus.

5. The relay apparatus according to claim 3, wherein the message further includes information regarding a scheduled time to stop the relay.

6. The relay apparatus according to claim 3, wherein the operations further comprise controlling, in a case where a connection request from one of a communication apparatus and another relay apparatus is received after transmission of the message, not to accept the connection request.

7. The relay apparatus according to claim 3, wherein the relay apparatus is an IAB node that performs relay based on Integrated Access and Backhaul (IAB) defined in the Third Generation Partnership Project (3GPP).

8. The relay apparatus according to claim 7, wherein the message is a Backhaul Adaptation Protocol (BAP) PDU in which a value indicating beforehand announcement of relay stop is set in a Protocol Data Unit (PDU) type field.

9. A relay apparatus included in a relay path that relays communication between a network and a terminal, comprising:
at least one memory that stores a set of instructions; and
at least one processor that executes the instructions, the instructions, when executed, causing the relay apparatus to perform operations comprising:
receiving a message concerning stop of relay from a first another relay apparatus provided on a first relay path that relays wireless communication between the relay apparatus and the network on the relay path and connected to the relay apparatus; and
executing, based on reception of the message, connection processing for connection to a second another relay apparatus connectable to the network before the first other relay apparatus stops relay.

10. The relay apparatus according to claim 9, wherein the connection processing is processing for switching a connection destination from the first other relay apparatus to the second other relay apparatus before the first other relay apparatus stops relay.

11. The relay apparatus according to claim 9, wherein the connection processing is processing for searching for the second other relay apparatus before the first other relay apparatus stops relay, and switching a connection destination from the first other relay apparatus to the second other relay apparatus in accordance with stop of relay by the first other relay apparatus.

12. The relay apparatus according to claim 9, wherein the relay apparatus is an IAB node that performs relay based on Integrated Access and Backhaul (IAB) defined in the Third Generation Partnership Project (3GPP).

13. The relay apparatus according to claim 12, wherein the operations further comprises transmitting, in a case where a Backhaul Radio Link Failure (BH RLF) is received from the first other relay apparatus, a message that notifies the BH RLF to a third another relay apparatus provided on a second relay path that relays wireless communication between the relay apparatus and the terminal on the relay path and connected to the relay apparatus.

14. The relay apparatus according to claim 13, wherein in a case where the message is received, the relay apparatus does not transmit the message to the third another relay apparatus.

15. The relay apparatus according to claim 9, wherein in a case where information indicating a candidate of the connection destination is included in the message, the second other relay apparatus that is a connection target is decided based on the information, and processing for connection to the decided second another relay apparatus is executed in the connection processing.

16. The relay apparatus according to claim 15, wherein in a case where the information indicating a candidate of the connection destination is not included in the message, the second other relay apparatus is selected from among other communication apparatuses based on reception strength of signals transmitted from the other communication apparatuses.

17. The relay apparatus according to claim 9, wherein in a case where information indicating a scheduled time to stop relay by the first other relay apparatus is included in the message, the relay apparatus completes the connection processing until the scheduled time.

18. The relay apparatus according to claim 9, wherein the message concerning stop of the relay is a message that announces stop of relay.

19. A method for providing a function as a relay node included in a relay path that relays communication between a network and a terminal, comprising:
transmitting, before the relay is stopped, a message concerning stop of relay to a first another relay apparatus provided on a first relay path that relays wireless communication between the relay node and the terminal on the relay path and connected to the relay apparatus,
wherein the message is not transmitted to a second another relay apparatus provided on a second relay path that relays wireless communication between the relay node and the network on the relay path and connected to the relay node, and the message is different from a message that notifies a Backhaul Radio Link Failure (BH RLF).

20. The method according to claim 19, wherein the message concerning stop of the relay is a message that announces stop of relay beforehand, and the function as the relay node is a function for performing relay based on Integrated Access and Backhaul (IAB) defined in the Third Generation Partnership Project (3GPP).
